(19) United States
(12) Patent Application Publication
(10) Pub. No.: US 2017/0023495 A1
(43) Pub. Date: Jan. 26, 2017

(54) UNIVERSAL COMPUTERIZED TOMOGRAPHY FIXTURE SYSTEM WITH A MULTI-SCAN ROBOTIC POSITIONING APPARATUS

(71) Applicant: Apple Inc., Cupertino, CA (US)

(72) Inventors: Javier D. Santillan, San Francisco, CA (US); Krystle C. Catalli, San Jose, CA (US); Alexis A. Hakimi, Los Angeles, CA (US); Nicholas S. Reimnitz, Campbell, CA (US)

(21) Appl. No.: 14/804,245

(22) Filed: Jul. 20, 2015

(51) Int. Cl. G01N 23/04

(52) U.S. Cl. CPC G01N 23/046; G01N 2223/309

(57) ABSTRACT

A fixture and a method for using a fixture in a computerized tomography (“CT”) scan system of an electronic device are disclosed. The fixture is designed to reduce attenuation of radiation passing through the fixture to improve the CT imaging, particularly the imaging of one or more components in the electronic device. For example, the fixture may include a support column having a first support wall and a second support wall that define a space in the support column. Also, the support column may be offset with respect to a base portion of the fixture such that a component scanned in the CT scan system is positioned along a center of rotation of the fixture. Alternatively, or in combination, the fixture may be secured to a motorized device that actuates the fixture in two dimensions to align the component along the center of rotation.

### FIELD

The described embodiments relate to a fixture apparatus. In particular, the described embodiments relate to a fixture used with a computerized tomography (“CT”) scanning operation to secure one or more devices that undergo radiation (X-ray) exposure in order to analyze the device, or devices.

### BACKGROUND

A device may undergo an X-ray scan to make one or more determinations regarding the device. A fixture, or securing mechanism, may be used to hold the device in place during the X-ray scan. In order for radiation from the X-scan to more readily pass to a detection area, the fixture may be made from “X-ray transparent” materials.

One solution is to adhesively secure the device to a foam fixture. However, the foam fixture must be custom made for each structure. This becomes a time-consuming procedure, particularly when the device comes in a variety of sizes and shapes. Also, the foam fixture is not typically reusable and therefore wasteful. Another solution is to use a wood fixture. However, the wood fixture may include similar issues. For example, the wood fixture is not customizable. Also, additional time passes when waiting for an adhesive to cure causing additional time dedicated to the X-ray scan process.

Other solutions may provide a clamping force to secure the device with a fixture. However, in some cases, the clamping force causes damage to the device.

### SUMMARY

In one aspect, a fixture suitable for exposure to a radiation source to perform a computerized tomography scan to a component of a device is described. The fixture may include a base portion designed to secure with a rotary device to actuate the base portion about a center of rotation of the base portion. The fixture may further include a support column extending from the base portion and actuated in accordance with the base portion. The support column may include an internal support structure that minimizes an attenuation of radiation from the radiation source passing through support column. In some embodiments, the support column is offset with respect to the base portion to allow the component to align with the center of rotation.

In another aspect, a system used to perform computerized tomography (CT) scanning of a first device having a first component and a second device having a second component is described. The system may include a radiation source that emits radiation. The system may further include a detection mechanism that receives the radiation source. The system may further include a fixture positioned between the radiation source and the detection mechanism. The system may further include a rotary device designed to actuate the fixture in a rotational manner. The system may further include a motorized device designed to actuate the fixture in a first dimension and second dimension different from the first dimension. In some embodiments, the motorized device aligns the first component along a first center of rotation to perform a first CT scan of the first component and subsequently aligns the second component along a second center of rotation different from the first center of rotation to perform a second CT scan of the second component.

In another aspect, a method for performing a computerized tomography scan of a first electronic device having a first component and a second electronic device having a second component is described. In one embodiment, the first electronic device and the second electronic device are each secured to a fixture. The method includes receiving a first radiation at the first component. The method may further include, while receiving the first radiation, receiving a first rotational force to rotate the fixture about a first center of rotation having a first longitudinal axis extending through the first component. The method may further include receiving a second radiation at the second component. The method may further include, while receiving the second radiation, receiving a second rotational force to rotate the fixture about a second center of rotation having a second longitudinal axis extending through the second component, the second center of rotation different from the first center of rotation.

Other systems, methods, features and advantages of the embodiments will be, or will become, apparent to one of ordinary skill in the art upon examination of the following figures and detailed description. It is intended that all such additional systems, methods, features and advantages be included within this description and this summary, be within the scope of the embodiments, and be protected by the following claims.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates an isometric view of an embodiment of a fixture suitable for use with a CT scan, in accordance with the described embodiments;

FIG. 2 illustrates a rear view of the fixture shown in FIG. 1, showing several hook features extending along the support column;

FIG. 3 illustrates a plan view of the fixture shown in FIG. 1, showing the positioning of the support column with the respect to the base portion;

FIG. 4 illustrates a front view of the fixture having a first electronic device and a second electronic device secured with the fixture;

FIG. 5 illustrates a side view of a fixture showing an electronic device positioned at an angle with respect to a support column, in accordance with the described embodiments;

FIG. 6 illustrates an isometric view of a system used to perform CT scanning operation, in accordance with the described embodiments;

FIG. 7 illustrates a plan view of the fixture shown in FIG. 6, showing several paths taken by radiation from the radiation source;

FIG. 8 illustrates a plan view of the motorized device shown in FIG. 6 used to actuate the fixture;

FIG. 9 illustrates a front view of the fixture shown in FIG. 6, with a first component of a first electronic device positioned along a first center of rotation of the fixture;

FIG. 10 illustrates an isometric view of the system shown in FIG. 6, with the radiation source elevated to emit a second radiation in a direction toward the second electronic device;

FIG. 11 illustrates a front view of the fixture, with a second component of a second electronic device positioned along a second center of rotation of the fixture;

FIG. 12 illustrates an alternate embodiment of a fixture, in accordance with the described embodiments;

FIG. 13 illustrates an isometric view of an alternative embodiment of a fixture including a base portion designed to mate with a protruding feature to allow the fixture to slide along the protruding feature;

FIG. 14 illustrates an isometric view of an alternate embodiment of a fixture having several discrete adhesive features disposed throughout a support column of the fixture;

FIG. 15 illustrates an isometric view of an alternative embodiment of a fixture secured with an angled feature allowing the fixture to slide along the angled feature;

FIG. 16 illustrates a side view of a post designed to secure with a fixture to position the fixture at an angle with respect to a horizontal plane; and

FIG. 17 illustrates a flowchart showing a method for performing a computerized tomography scan of a first electronic device having a first component and a second electronic device having a second component.

Those skilled in the art will appreciate and understand that, according to common practice, various features of the drawings discussed below are not necessarily drawn to scale, and that dimensions of various features and elements of the drawings may be expanded or reduced to more clearly illustrate the embodiments of the present invention described herein.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting such that other embodiments may be used, and changes may be made without departing from the spirit and scope of the described embodiments.

The following disclosure relates to a fixture designed to receive an electronic device (or devices) in order to perform a computerized (or computed) tomography (“CT”) scan of the electronic device. CT scanning may include a radiation source that emits radiation, such as X-ray radiation, some of which penetrates through the electronic devices as well as the fixture. The radiation passing through the fixture and the electronic device may be received at a detection mechanism to create a two-dimensional image of the electronic device. Further, while receiving the radiation, the fixture and the electronic device may be rotated 360 degrees around a longitudinal axis extending defining a center of rotation (or axis of rotation) of the fixture to produce multiple two-dimensional images. Each two-dimensional image may be an image of the electronic device orientated at an angle, including a fraction of an angle, with respect to the radiation source. These two-dimensional images may combine to define a three-dimensional image of the electronic device.

The resultant three-dimensional image of the CT scan can be used to analyze the electronic device. For example, the image can determine whether an internal component of the electronic, such as a button or a camera module, is properly assembled in accordance with a design specification of the electronic device. Further, the image may determine whether the internal component was damaged during assembly.

The fixture may be made from one or more materials that allow the radiation to readily pass through the fixture. For example, the fixture may be formed from a polymeric material such as plastic. In this regard, the fixture may be formed using a three-dimensional printing apparatus (“3D printer”) allowing the fixture to include a variety of customizable sizes and shapes to carry a variety of electronic devices. A “three-dimension printer” refers to a printing apparatus that emits a polymeric material in order to form a three-dimensional structure. However, the fixture may be formed by other methods. For example, the fixture may include a polymeric material injected molded into a mold cavity that defines the size and shape of the fixture. Further, the fixture may be formed from a block of polymeric material that undergoes a material removal process.

In order to improve image quality of the CT scanning operation, the fixture may include additional features. For example, in addition to using a polymeric material, the fixture may include a support column designed to receive the electronic device and minimize attenuation of the radiation. In this regard, the support column may include support walls, such as a first support wall and a second support wall intersecting the first support wall. The first support wall and the second support wall combine to provide structural support, particularly when the support column is designed for two or more electronic devices. The first support wall and the second support wall define several spaces are voids between the first support wall and the second support wall. Rather than a continuous block of polymeric material, the spaces allow additional radiation, or limit attenuation of the radiation, through the support column.

In order to receive the electronic device, the support column may include an adhesive feature. When the fixture is formed used a three-dimensional printer, an additional material defining the adhesive feature may be printed onto the support column. Further, the adhesive feature may include a reusable adhesive feature. Accordingly, unlike traditional fixtures that use a non-reusable adhesive (such as epoxy or glue), the reusable adhesive feature allows the fixture to be reused in several CT scanning operations. Further, the adhesive feature may include an indented region extending along the adhesive feature. The indented region may be disposed at a center of the support column to define a centerline used to align the electronic device.

In addition to the support column, the fixture may further include a base portion. The base portion may be design to couple with one or more actuating devices. For example, the base portion may couple with a rotary device designed to rotate the fixture in manner previously described. The rotary device may be a motorized chuck. Also, each analyzed component scanned in the electronic device is positioned such that when the electronic device is rotated, the component is at a center of rotation. In this manner, the fixture may be designed such that the support column is offset with respect to the base portion such that the component may be positioned at the center of rotation. In other words, the support column shown in this detailed description may appear to include a semi-circular shape. However, the support column is designed not to be a complete half circle, and accordingly, is designed not to occupy a central region of the base portion defined by the center of rotation.

The fixture may include alternative or additional features used to position the component along the center of rotation. For example, the base portion may couple with a motorized device designed to actuate the fixture in two dimensions. In this regard, the motorized device may include a two dimensional stage that actuates the fixture in an x-dimension and a y-dimension, allowing for fine-tuning adjustments. Further, when multiple components in the electronic device are scanned using the CT scanning system, the motorized device may be used to adjust the fixture and the electronic device such that each component is positioned along a center of rotation during the CT scan. Also, when the fixture carries multiple electronic devices to undergo scanning using the CT scanning system, the motorized device may be used to adjust the fixture and each electronic device such that each component to be scanned in each electronic device is positioned along a center of rotation during the CT scan.

Also, in addition to electronic device, the fixture and CT scanning system may be used to create a three-dimensional image of other internal components. For example, an integrated circuited or a printed circuit board may be analyzed by the image to determine proper positioning as well as damage. Further, a battery pack having several layers may be suitable for undergoing a CT scanning operation.

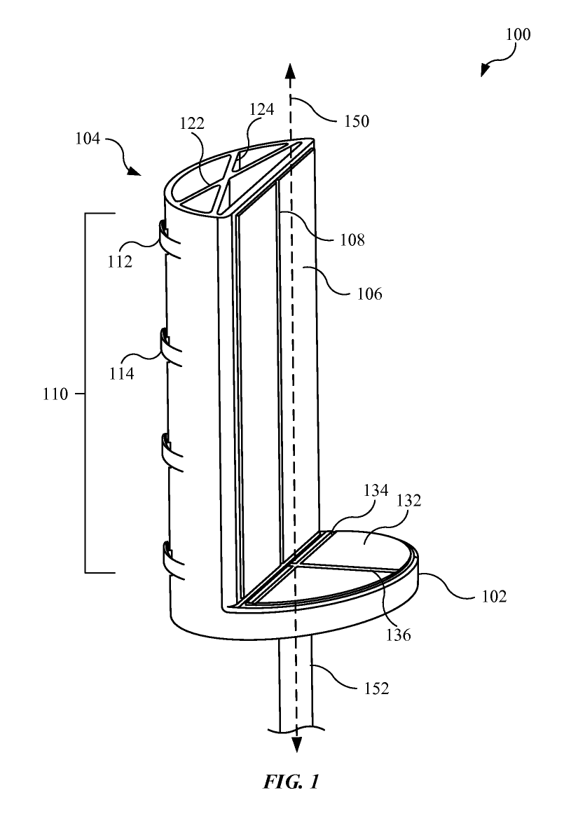

These and other embodiments are discussed below with reference to FIGS. 1-17. However, those skilled in the art will readily appreciate that the detailed description given herein with respect to these Figures is for explanatory purposes only and should not be construed as limiting.

FIG. 1 illustrates an isometric view of an embodiment of a fixture 100 suitable for use with a CT scan, in accordance with the described embodiments. In some embodiments, the fixture 100 is formed from a polymeric material (such as plastic) using a three-dimensional printer. Accordingly, although the fixture 100 is shown having a particular size and shape, the fixture 100 may include a variety of sizes and shapes. As shown, the fixture 100 includes a base portion 102 and a support column 104 extending from the base portion 102. The support column 104 is designed to carry one or more electronic devices, such as a mobile communications device (including a smartphone), a tablet computing device, and/or a laptop computing device. Accordingly, the support column 104 may vary in size and shape based upon the size and shape of the electronic device.

In order to secure an electronic device with the fixture 100, the support column 104 may include an adhesive feature 106 disposed across a generally flat portion of the support column 104. In some embodiments, the adhesive feature 106 is an adhesive rubber. Also, in some embodiments, the adhesive feature 106 is formed in a continuous process with the fixture 100. For example, a three-dimensional printer used to form the support column 104 can also print material to define the adhesive feature 106. Also, unlike traditional adhesives that may cure and be used only once, the adhesive feature 106 may be used to secure an electronic device in several subsequent operations. In other words, the adhesive feature 106 may be a reusable adhesive feature. Also, in order to align the electronic device with the support column 104, the adhesive feature 106 may include an indented region 108 extending along the adhesive feature 106. The indented region 108 may extend along a center (vertical center, as shown) of the support column 104 to define a centerline of the support column 104. This may assist in aligning, manually or automatically, an electronic device with respect to support column 104.

In addition to the adhesive feature 106, the fixture 100 may include additional structural features designed to secure an electronic device. For example, the fixture 100 may include a first hook feature 112 and a second hook feature 114. When the electronic device is adhesively secured with the adhesive feature 106, an elastic material (not shown) wraps around the electronic device and couples with the first hook feature 112 and the second hook feature 114. In some embodiments, the hook features are integrally formed with the support column 104. The phrase “integrally formed” as used throughout this detailed description and in the claims refers to a structure formed from the same material or materials using a single, continuous process. For example, when the support column 104 is formed using a three-dimensional printer, the three-dimension printer can emit the same material or materials during the printing process to form the first hook feature 112 and the second hook feature 114.

During a CT scanning operation, radiation, such as X-ray radiation, may be attenuated or blocked when passing through an object or objects. In order to reduce attenuation in the fixture 100 and continue to provide structural support, the support column 104 includes a first support wall 122 and a second support wall 124 intersecting with the first support wall 122. As shown, the first support wall 122 and the second support wall 124 are disposed in the support column 104. Also, the first support wall 122 and the second support wall 124 may extend the entire length of the support column 104 from a first end of the support column 104 to a second end of the support column 104 opposite the first end. Accordingly, the first support wall 122 and the second support wall 124 may define one or more spaces or voids in the support column 104. The spaces or voids represent air that allows radiation to pass more freely through the support column 104.

In some embodiments, the base portion 102 includes an adhesive feature. In the embodiment shown in FIG. 1, the base portion 102 includes a layer 132 of material having a coefficient of friction greater than that of the material or materials used to form the base portion 102. The layer 132 of material may limit movement of an electronic device in contact with the layer 132 of material to assist in positioning the electronic device. Also, the layer 132 of material may further include a first indented region 134 and a second indented region 136 to define a crosshair in the layer 132 of material. As shown, a longitudinal axis 150 represented as an imaginary line extends through a central region of a post 152 secured with the base portion 102 and through an uppermost region of the support column 104. The longitudinal axis 150 may represent a center of rotation of the fixture 100. For example, when the post 152 is secured with a rotary device, the fixture 100 is designed to rotate about the longitudinal axis 150. Ideally, a component of interest to be scanned using the CT scanning operation is aligned along the center of rotation.

Further, in order to align a component with the center of rotation, the support column 104 may be offset with respect to the base portion 102 such that the support column 104 does not occupy the center of rotation. For example, the support column 104 may include a size and a shape less than a full semi-circle, or half-circle. In this manner, by not occupying the center of rotation, the support column 104 allows a component to occupy the center of rotation.

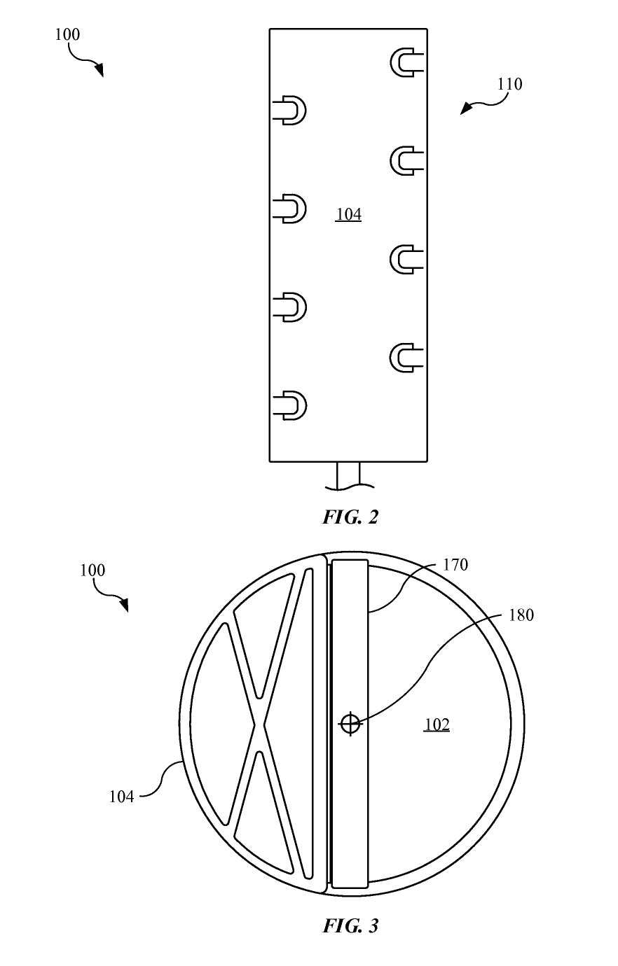

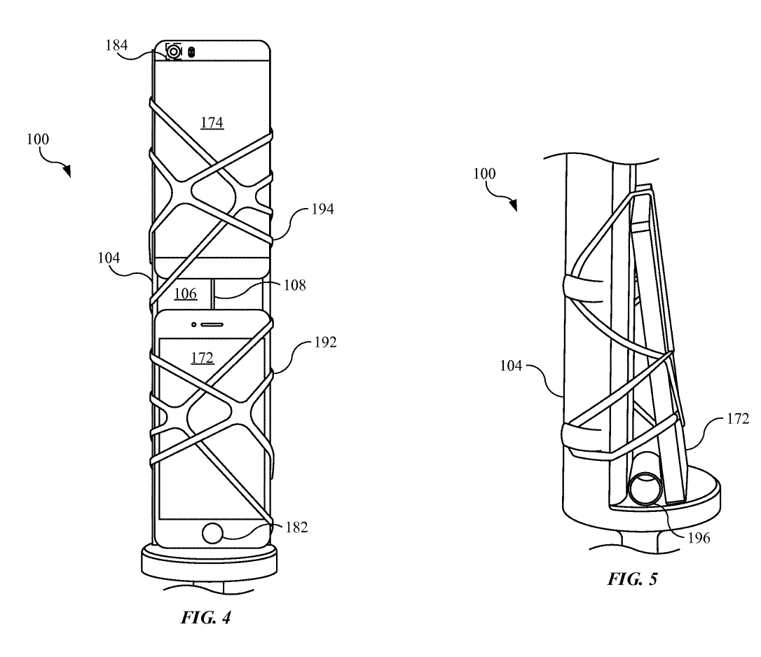

FIG. 2 illustrates a rear view of the fixture 100 shown in FIG. 1, showing several hook features extending along the support column 104. Although a discrete number of hook features are shown, the support column 104 may include any number of hook features. FIG. 3 illustrates a plan view of the fixture 100 shown in FIG. 1, showing the positioning of the support column 104 with the respect to the base portion 102. As shown, the fixture 100 further includes an electronic device 170 secured with the fixture 100. With the support column 104 offset with respect to the base portion 102, the electronic device 170 (or any of its components) may be positioned along a center of rotation 180 of the fixture 100.

FIGS. 4 and 5 illustrate a fixture having electronic devices secured with the fixture 100 using elastic features. In some embodiments, the elastic features include rubber bands. FIG. 4 illustrates a front view of the fixture 100 having a first electronic device 172 and a second electronic device 174 secured with the fixture 100. In addition to an adhesive feature 106, a first elastic feature 192 may secure the first electronic device 172 with the fixture 100 and a second elastic feature 194 may secure the second electronic device 174 with the fixture 100. Both the first elastic feature 192 and the second elastic feature 194 may be coupled with several hook features (such as those shown in FIG. 2) of the support column 104.

Also, as shown, the first electronic device 172 includes a first component 182 that may undergo a CT scan to determine, for example, whether the first component 182 is damaged or whether the first component 182 is properly aligned. In some embodiments, the first component 182 is a button designed to input a command to the first electronic device 172. After a CT scan of the first component 182, the radiation source may be repositioned to perform a CT scan of the second electronic device 174, and in particular, a second component 184 of the second electronic device 174. In some embodiments, the second component 184 is a camera module designed to capture an image. Unlike the first component 182, the second component 184 is not aligned with respect to the indented region 108. However, the fixture 100 may be secured to a motorized device (not shown) that actuates the fixture 100 such that the second component 184 is positioned along a center of rotation. This will be discussed in detail below.

FIG. 5 illustrates a side view of a fixture 100 showing the first electronic device 172 positioned at an angle with respect to the support column 104, in accordance with the described embodiments. As shown, a cylindrical feature 196 may be positioned between the support column 104 and the first electronic device 172 in order to angle an internal component of the first electronic device 172 and improve the image quality of a CT scan operation of the internal component. The cylindrical feature 196 may be formed from a “radiation-transparent” material, such as a polymeric material including plastic. Also, the cylindrical feature 196 is hollow in order to reduce attenuation of radiation passing through the cylindrical feature 196.

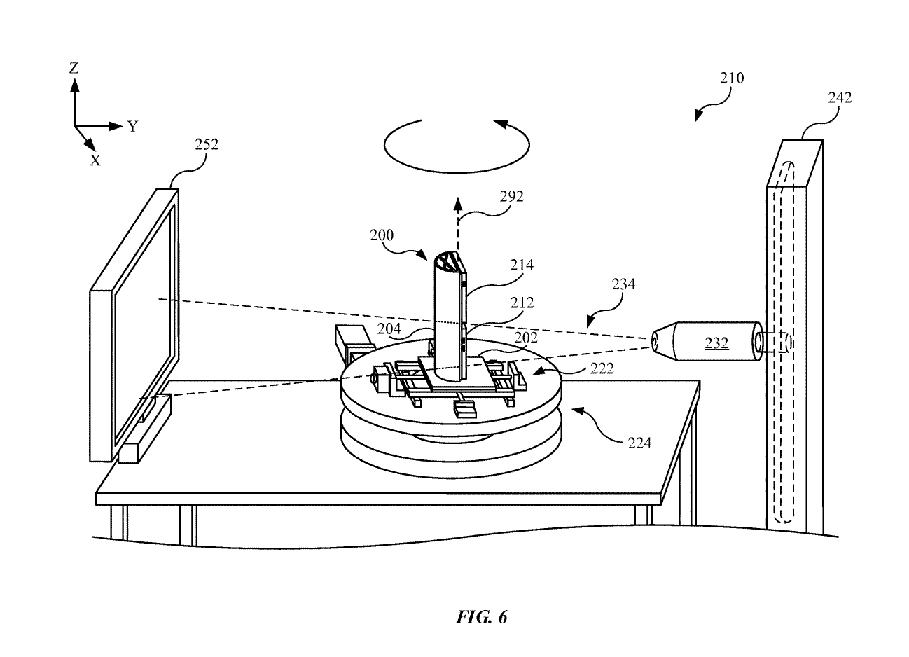

FIG. 6 illustrates an isometric view of a system 210 used to perform CT scanning operation, in accordance with the described embodiments. The system 210 may include a fixture 200 that may include any properties previously described for a fixture. As shown, the fixture 200 includes a base portion 202 and a support column 204, with the support column 204 carrying a first electronic device 212 and a second electronic device 214. Accordingly, the system 210 may be referred to as a CT multi-scanning system as the system 210 is designed to perform a CT scan to multiple devices in a single operation. In other embodiments, the fixture 200 is designed to carry three or more electronic devices. In this manner, the system 210 is designed to save significant time over traditional systems designed to scan only one device at a time.

The system 210 may further include a motorized device 222 coupled with the base portion 202. The motorized device 222 is designed to actuate the fixture 200, and accordingly the electronic devices secured with the fixture 200, in multiple dimension, such as an x-dimension and a y-dimension. The motorized device 222 may include one or more motors designed to actuate the fixture 200 in the multiple dimensions. This allows the system 210 to align a component (not shown) of either the first electronic device 212 and/or the second electronic device 214 along a center of rotation defined by a first longitudinal axis 292.

The system 210 may further include a rotary device 224 coupled with the base portion 202 and/or the motorized device 222. The rotary device 224 designed to actuate the fixture 200, and accordingly the electronic devices secured with the fixture 200, in a rotational manner about the first longitudinal axis 292. The rotary device 224 is designed to provide 360-degree rotation to the fixture 200. In some embodiments, the rotatory device 224 includes a chuck that secures a post (not shown) coupled with or integrally formed with the base portion 202. Also, the rotary device 224 may be coupled with the motorized device 222.

The system 210 may further include a radiation source 232. In some embodiments, the radiation source 232 is an X-ray radiation source that emits X-ray radiation designed to penetrate the fixture 200 and the electronic devices. The radiation source 232 is secured with a motorized column 242 designed to actuate the radiation source 232 along the z-dimension such that the radiation source 232 emits radiation to any device secured with the fixture 200. As shown, the radiation source 232 emits a first radiation 234 directed to a first component (not shown) of the first electronic device 212. Prior to emission of the first radiation 234, the motorized device 222 may the first component along the first longitudinal axis 292. However, while the rotary device 224 is rotating the fixture 200 and the first electronic device 212, the system 210 is designed such that the radiation source 232 emits the first radiation 234. Further, during a 360-degree rotation of the fixture 200 and the first electronic device 212, a detection mechanism 252 is designed to capture the first radiation 234 passing through the fixture 200 and the first electronic device 212 at each degree, or fraction of a degree, of rotation. The detection mechanism 252 can send the first radiation 234 captured at each degree or fraction of a degree to a computing system (not shown) that creates a two-dimensional image of the first electronic device 212 to analyze the first component. Further, the computing system can use the two-dimensional images to define a three-dimensional image of the first electronic device 212 and the first component. The three-dimensional image of the first component can be used for various purposes. For example, the three-dimensional image may assist in determining whether the first component is properly aligned according to design specification, or whether the first component is damaged during assembly.

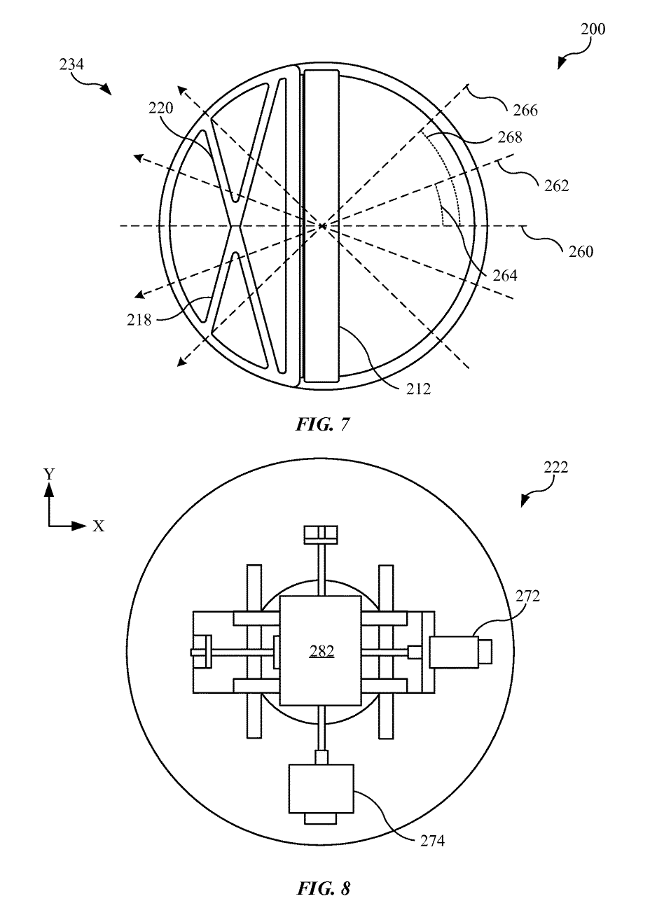

FIG. 7 illustrates a plan view of the fixture 200 shown in FIG. 6, showing several paths taken by the first radiation 234 from the radiation source 232. As shown, the fixture 200 includes a first support wall 218 and a second support wall 220 intersecting the first support wall 218. The first support wall 218 and the second support wall 220 are designed not only provide stability to the fixture 200 but also to minimize attenuation of the first radiation 234 passing through the first electronic device 212 and the fixture 200. Further, throughout various orientations or angles with respect to the radiation source 232 (shown in FIG. 6), the first support wall 218 and the second support wall 220 allow the first radiation 234 to pass through the fixture 200 at approximately the same magnitude. For example, FIG. 7 shows the first radiation 234 along a first path 262 at a first angle 264 with respect to a horizontal plane 260. Also, the first radiation 234 is shown at a later time along a second path 266 at a second angle 268 with respect to the horizontal plane 260, with the second angle 268 different from the first angle 264. As shown, the first radiation 234, when passing through the fixture 200 along the first path 262 or the second path 266, passes through the same structural features of the fixture 200, namely the first support wall 218, the second support wall 220, and an outer wall of the fixture 200. This is due in part to the relatively high angle of intersection between the first support wall 218 and the second support wall 220. This allows for improved imaging of the components in the electronic device.

FIG. 8 illustrates a plan view of the motorized device 222 shown in FIG. 6 used to actuate the fixture 200. As shown, the motorized device 222 includes a first motor 272 designed to actuate a platform 282 in a first dimension, such as the x-dimension. Also, the motorized device 222 includes a second motor 274 designed to actuate the platform 282 in a second dimension, such as the y-dimension. Also, the motorized device 222 to provide low-profile actuation means for the system 210 (shown in FIG. 6) along with high accuracy. For example, in some embodiments, the overall height of the motorized device 222 is less than 40 millimeters. Also, in some embodiments, the first motor 272 and the second motor 274 are designed to actuate the platform 282 a distance as small as a few micrometers. This provides accurate placement of a device, and in particular a component placed in a center of rotation in a manner previously described.

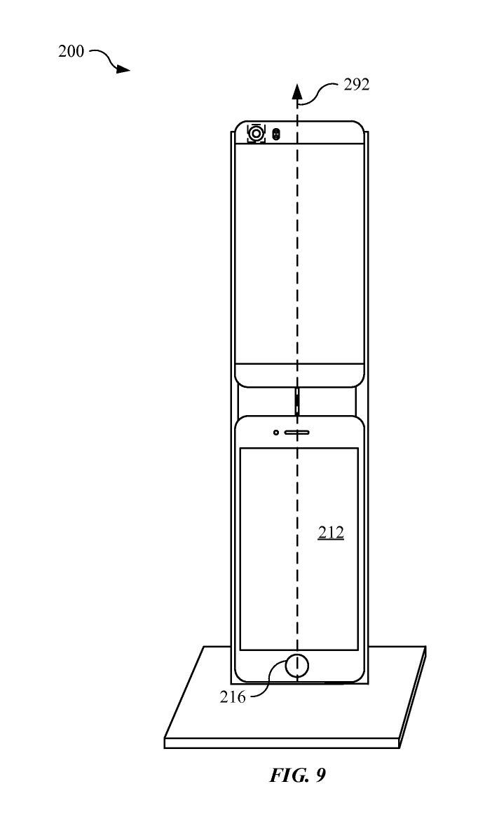

FIG. 9 illustrates a front view of the fixture shown in FIG. 6, with a first component 216 of a first electronic device 212 positioned along a first center of rotation of the fixture 200. In some embodiments, the first component 216 is an input device, such as a button, designed to input a command to the first electronic device 212. The first center of rotation may be defined by the first longitudinal axis 292 (shown in FIG. 6). In order to perform a CT scan operation using the system 210 (shown in FIG. 6), the motorized device 222 (shown in FIG. 8) is designed to position the first component 216 in the manner shown in FIG. 9.

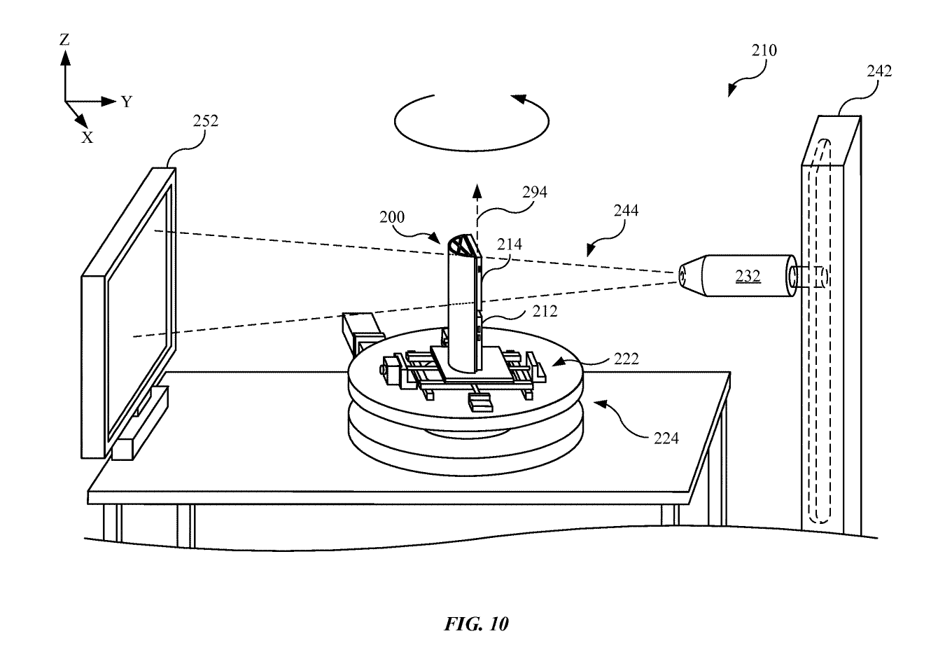

FIG. 10 illustrates an isometric view of the system 210 shown in FIG. 6, with the radiation source 232 elevated to emit a second radiation 244 in a direction toward the second electronic device 214. As shown, the radiation source 232 is actuated in the z-direction by the motorized column 242 such that the radiation source 232 emits a second radiation 244 through the fixture 200 and the second electronic device 214, and to the detection mechanism 252. In some cases, a component in the second electronic device 214 is a different component that the component in the first electronic device 212. This may include a different location and/or a different structural component. Accordingly, in some cases, the component in the second electronic device 214 is not located along a center of rotation. However, the motorized device 222 is designed to actuate the fixture 200 such that the component in the second electronic device 214 is positioned along a second center of rotation defined by the second longitudinal axis 294 extending along the second center of rotation, and shifted from the first longitudinal axis 292 (shown in FIG. 6). In this manner, the rotary device 224 rotates the fixture 200 in a manner previously described, and in particular, the rotary device 224 rotates about the second longitudinal axis 294. It will be appreciated that several two-dimensional images, and a subsequent three-dimensional image, of the second electronic device 214 (and the component in the second electronic device 214) may be collected similar a manner to analyze the second component.

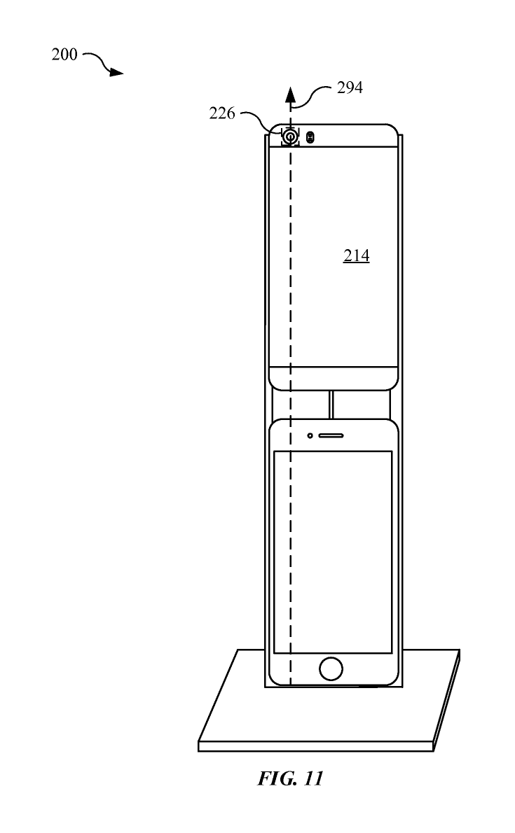

FIG. 11 illustrates a front view of the fixture 200, with a second component 226 of the second electronic device 214 positioned along a second center of rotation of the fixture 200. The second center of rotation may be defined by the second longitudinal axis 294 (shown in FIG. 10). In some embodiments, the second component 226 is a camera module designed to capture an image. In order to perform a CT scan using the system 210 (shown in FIG. 10), the motorized device 222 (shown in FIG. 8) is designed to position the second component 216 in the manner shown in FIG. 11.

Also, although not shown, in some embodiments, the system 210 is designed to include a single center of rotation and accordingly the second longitudinal axis 294 (shown in FIG. 10) is located in the same position as the first longitudinal axis 292 (shown in the FIG. 6). For example, the motorized device 222 may position any component in any electronic device secured with the fixture 200 along the single center of rotation, and the rotary device 224 may rotate the fixture 200 with these components at the single center of rotation.

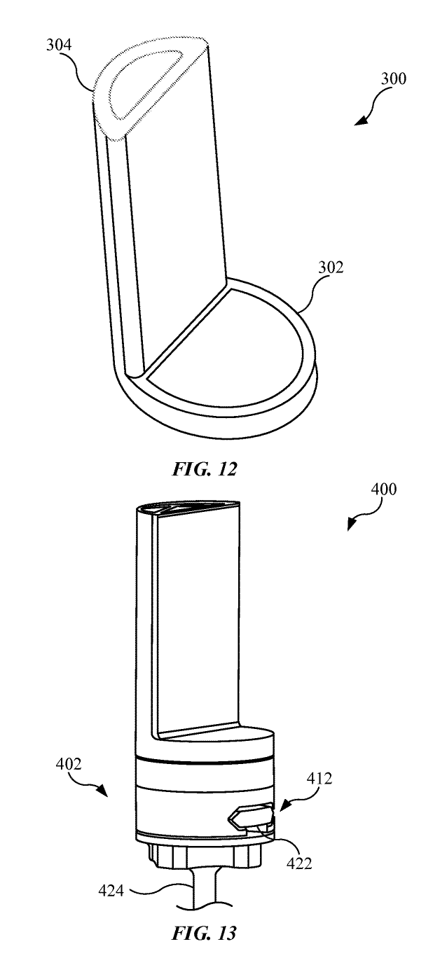

FIGS. 12-14 illustrate alternate embodiments of a fixture. These fixtures may be used in a CT scanning system, such as the system 210 (shown in FIG. 6). Also, the fixtures shown in FIGS. 12-14 may include any property, feature, or material (or materials) previously described for a fixture.

FIG. 12 illustrates an alternate embodiment of a fixture 300, in accordance with the described embodiments. Similar to previous fixtures, the fixture 300 shown in FIG. 12 includes a base portion 302 and a support column 304, with the support column 304 designed to receive one or more electronic devices. However, the support column 304 does not include multiple support walls. The fixture 300 may be ideal for relatively smaller electronic devices, such as an MP3 player.

FIG. 13 illustrates an isometric view of an alternative embodiment of a fixture 400 including a base portion 402 having an opening 412 designed to mate with a protruding feature 422, allowing the fixture 400 to slide along the protruding feature 422 secured with a post 424. The post 424 may be inserted into a rotary device designed to rotate the fixture 400 in a manner previously described. The base portion 402 and the protruding feature 422 may allow for similar manual adjustment of the fixture 400 to, for example, align a component in an electronic device along the center of rotation such that the component may undergo a CT scanning operation.

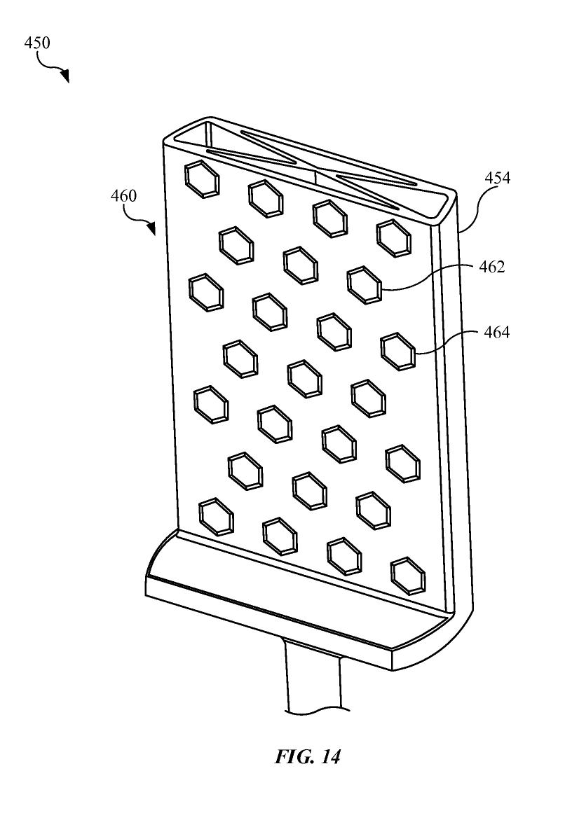

FIG. 14 illustrates an isometric view of an alternate embodiment of a fixture 450 having discrete adhesive features 460 disposed throughout a support column 454 of the fixture 450. For example, the discrete adhesive features 460 may include a first adhesive feature 462 and a second adhesive feature 464. The discrete adhesive features 460 are designed to reduce an amount of adhesion force of the fixture 450. This may facilitate removing an electronic device from the fixture subsequent to a CT scan. The reduced adhesion force may prevent damage to the electronic device when removing the electronic device from the fixture 450. The discrete adhesive feature 460 may be formed in any manner previously described for an adhesive feature, including the use of a three-dimensional printer. Also, although the discrete adhesive features 460 as shown include a discrete shape, the discrete adhesive feature 460 may include any number of polygonal shapes.

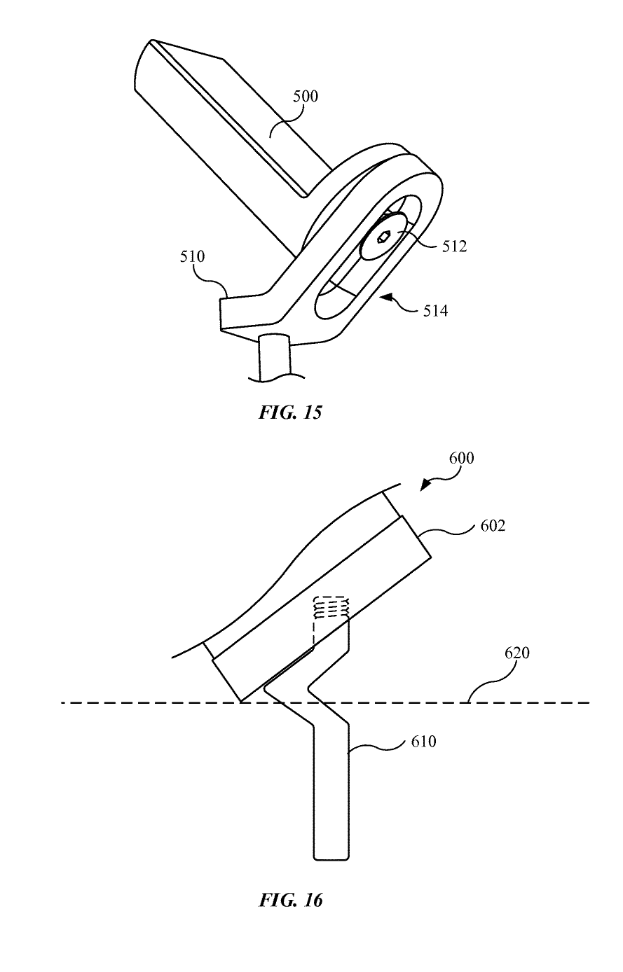

FIG. 15 illustrates an isometric view of an alternative embodiment of a fixture 500 secured with an angled feature 510 allowing the fixture 500 to slide along the angled feature 510. The fixture 500 may be secured with the angled feature 510 by a fastener 512 extending through an opening 514 of the angled feature 510. In some embodiments, the fastener 512 is formed from a polymeric material using a three-dimensional printer. In this manner, the fastener 512 is formed from a material that minimizes attenuation of radiation, such as X-ray radiation. The fixture 500 includes a threaded opening (not shown) to receive a threaded region (not shown) of the fastener 512. In this manner, the fastener 512 may be driven or screwed in one direction to loosen the fixture 500 from the angled feature 510 to allow the fixture 500 to slide along the angled feature 510 in order to shift the center of rotation. The fastener 512 may then be driven in the other direction to tighten the fixture 500 against the angled feature 510. The angled feature 510 may be beneficial for performing a CT scanned to a layered feature, such as a battery pack.

FIG. 16 illustrates a side view of a post 610 designed to secure with a fixture 600 to position the fixture 600 at an angle with respect to a horizontal plane 620. As shown, the base portion 602 of the fixture 600 may include a threaded region designed for threaded engagement with the post 610. The post 610 provides an alternative solution to positioning a component at an angle.

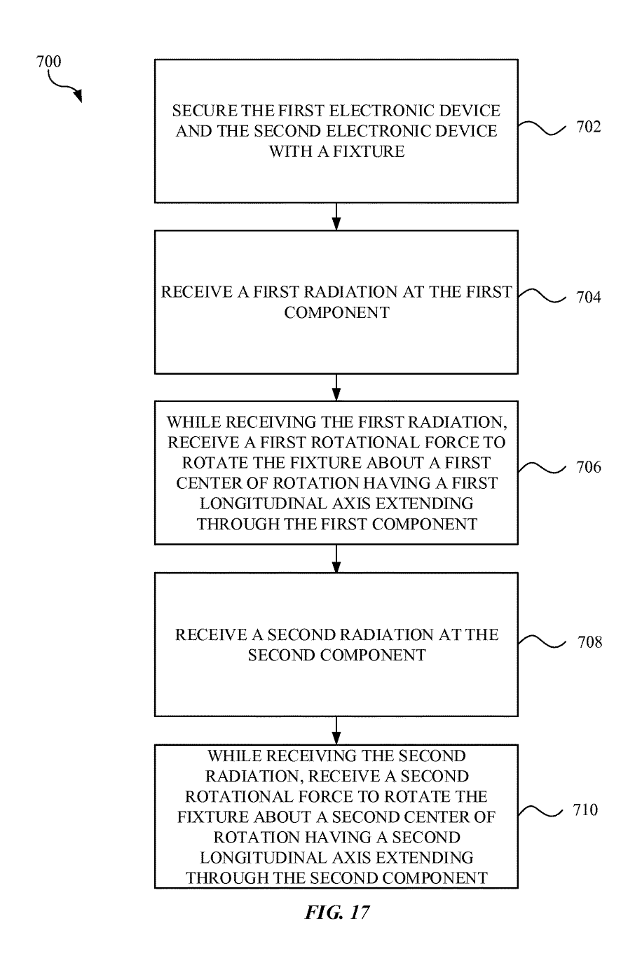

FIG. 17 illustrates a flowchart 700 showing a method for performing a computerized tomography scan of a first electronic device having a first component and a second electronic device having a second component. The flowchart 700 may represent a multi-scan CT system. In step 702, the first electronic device and the second are secured with a fixture. The fixture may include a base portion and a support column. The support column may include an adhesive feature designed to secure the electronic devices with the fixture. Further, the support column may include hook features integrally formed with the support column and designed to receive one or more elastic members (such as rubber bands) that wrap around the electronic devices. Also, the support column may include several support walls to minimize attenuation of radiation passing through the fixture.

In step 704, a first radiation is received at the first component. The first radiation may include X-ray radiation emitted from a radiation source. In step 706, while receiving the first radiation, a first rotational force is received to rotate the fixture about a first center of rotation having a first longitudinal axis extending through the first component. The first rotational force may rotate the fixture and the electronic devices in a 360-degree rotation. The radiation may pass through the first component and the fixture, and on to a detection mechanism. At each angle, or fraction of an angle, the detection mechanism may receive the first radiation to assist in forming a two-dimensional image of the first component. The two-dimensional images may be collected and combine to define a three-dimensional image of the first component.

In step 708, a second radiation at the second component. The second radiation may also be X-ray radiation emitted from the radiation source. In step 710, while receiving the second radiation, a second rotational force is received to rotate the fixture about a second center of rotation having a second longitudinal axis extending through the second component. The second center of rotation may be different from the first center of rotation. Accordingly, the second longitudinal axis may be different from the first longitudinal axis. The second rotational force may rotate the fixture and the electronic devices in a 360-degree rotation. The radiation may pass through the second component and the fixture, and on to the detection mechanism. At each angle, or fraction of an angle, the detection mechanism may receive the second radiation to assist in forming a two-dimensional image of the second component. The two-dimensional images may be collected and combine to define a three-dimensional image of the second component.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A fixture suitable for exposure to a radiation source to perform a computerized tomography scan to a component of a device, the fixture comprising:
a base portion designed to secure with a rotary device to actuate the base portion about a center of rotation of the base portion;
a support column extending from the base portion and actuated in accordance with the base portion, the support column comprising an internal support structure that minimizes an attenuation of radiation from the radiation source passing through support column; and
wherein the support column is offset with respect to the base portion to allow the component to align with the center of rotation.

2. The fixture of claim 1, further comprising an adhesive feature to secure the device with the support column, and wherein the adhesive feature is a reusable adhesive feature.

3. The fixture of claim 2, wherein the internal support structure comprises a first support wall and a second support wall intersecting the first support wall, and wherein the first support wall and the second support wall are enclosed by the support column.

4. The fixture of claim 3, wherein the support column further comprises a first hook feature and a second hook feature, wherein the first hook feature and the second hook feature are designed to a receive an elastic feature that further secures the device with the support column, and wherein the first hook feature and the second hook feature are integrally formed with the support column.

5. The fixture of claim 3, wherein the attenuation of the radiation is approximately similar for a first orientation of the support column with respect to the radiation source and a second orientation of the support column with respect to the radiation source.

6. The fixture of claim 2, wherein the adhesive feature comprises an indented region to define a centerline of the support column.

7. The fixture of claim 1, wherein the base portion comprises a layer designed to increase a coefficient of friction of the base portion, wherein the layer comprises a crosshair to define the center of rotation.

8. A system used to perform computerized tomography (CT) scanning of a first device having a first component and a second device having a second component, the system comprising:
a radiation source that emits radiation;
a detection mechanism that receives the radiation source;
a fixture positioned between the radiation source and the detection mechanism;
a rotary device designed to actuate the fixture in a rotational manner; and
a motorized device designed to actuate the fixture in a first dimension and second dimension different from the first dimension, wherein the motorized device aligns the first component along a first center of rotation to perform a first CT scan of the first component and subsequently aligns the second component along a second center of rotation different from the first center of rotation to perform a second CT scan of the second component.

9. The system of claim 8, wherein the fixture comprises a support column that receives the first device and the second device, the support column comprising a first support wall and a second support wall disposed in the support column, the first support wall and the second support wall defining a space in the support column to allow the radiation to pass through the support column.

10. The system of claim 9, wherein the support column further comprises:
a first hook feature and a second hook feature, the first hook feature and the second hook feature integrally formed with the support column; and
an elastic feature that wraps around the first device and secures with the support column via the first hook feature and the second hook feature.

11. The system of claim 10, wherein the support column further comprises a reusable adhesive feature that further secures the first device with the support column.

12. The system of claim 11, wherein the reusable adhesive feature comprises discrete adhesive features.

13. The system of claim 11, wherein the reusable adhesive feature comprises an indented region to define a centerline of the support column.

14. The system of claim 9, wherein:
the support column includes a first end and a second end opposite the first end,
the first support wall crosses the second support wall, and wherein the first support wall, and
the first support wall and the second support wall extend from the first end to the second end.

15. A method for performing a computerized tomography scan of a first electronic device having a first component and a second electronic device having a second component, the first electronic device and the second electronic device each secured to a fixture; the method comprising:
receiving a first radiation at the first component;
while receiving the first radiation, receiving a first rotational force to rotate the fixture about a first center of rotation having a first longitudinal axis extending through the first component;
receiving a second radiation at the second component; and
while receiving the second radiation, receiving a second rotational force to rotate the fixture about a second center of rotation having a second longitudinal axis extending through the second component, the second center of rotation different from the first center of rotation.

16. The method of claim 15, wherein securing the first electronic device and the second electronic device to the fixture comprises adhesively securing the first electronic device and the second electronic device via a reusable adhesive feature disposed on the fixture.

17. The method of claim 15, further comprising receiving an actuation force in at least a first dimension to align the second component at the second center of rotation.

18. The method of claim 15, wherein the fixture comprises a support column that receives the first electronic device and the second electronic device, the support column comprising a first support wall and a second support wall disposed in the support column, the first support wall and the second support wall defining a space in the support column to allow the radiation to pass through the support column.

19. The method of claim 18, wherein the fixture comprises further comprises a base portion, and wherein the support column is offset with respect to the base portion to allow i) the first component to align along the first center of rotation and ii) the second component to align along the second center of rotation.

20. The method of claim 18, wherein the first support wall and the second support wall define a space in the support column that minimizes attenuation of the first radiation and the second radiation.
